(19) United States
(12) Patent Application Publication
(10) Pub. No.: US 2023/0303207 A1
(43) Pub. Date: Sep. 28, 2023

(54) Method for Controlling Motor Assistance provided by a Motor of an Electric Bike

(71) Applicant: Robert Bosch GmbH, Stuttgart (DE)

(72) Inventors: Merlin Martin Manewald, Reutlingen (DE); Joseph Reck, Filderstadt (DE); Matthias Weinmann, Balingen (DE); Sebastian Eberle, Tuebingen (DE); Christian Reisige, Tuebingen (DE); Daniel Baumgaertner, Neustetten (DE)

(21) Appl. No.: 18/185,563

(22) Filed: Mar. 17, 2023

(30) Foreign Application Priority Data
Mar. 25, 2022 (DE) 10 2022 202 975.5

(51) Int. Cl. B62M 6/50

(52) U.S. Cl. CPC B62M 6/50

(57) ABSTRACT

A method for controlling motor assistance provided by a motor of an electric bike is disclosed. The method includes determining a variable rate of change of a governing factor, which defines the extent to which a governing factor changes over a defined time interval The rate of change is selected such that the governing factor is decremented when a current speed is greater than a target speed, and the governing factor is incremented when the current speed is less than the target speed. The method further includes adjusting an existing governing factor based on the rate of change of the governing factor determined. The method also includes applying the governing factor calculated to a motor assistance determined for actuating the motor. A greater governing factor results in greater motor assistance than a comparatively lesser governing factor.

This application claims priority under 35 U.S.C. § 119 to patent application no. DE 10 2022 202 975.5, filed on Mar. 25, 2022 in Germany, the disclosure of which is incorporated herein by reference in its entirety.

### BACKGROUND

The present disclosure relates to a method for controlling motor assistance provided by a motor of an electric bike.

In the case of electric bikes, it is necessary that they can be governed in a speed-related manner. For example, such electric bikes need to be governed to a maximum assistance speed. In the EU, for example, it is necessary for pedelecs to be governed to 25 km/h without tolerance and for S-pedelecs to be governed to 45 km/h. Also, governing to different maximum assistance speeds is often desired for product differentiation, wherein more economical drives are, for example, governed to a lower speed than premium drives.

Typically, in order to govern to a maximum assist speed, the maximum allowable motor assistance (e.g., motor torque, motor power, and/or assistance ratio) is reduced as the speed increases. In this context, within a speed interval from, e.g., 20 km/h to 25 km/h, the maximum torque provided by the motor of the bike is reduced from full torque to a torque of 0. In the simplest case, a straightforward linear interpolation is used for this purpose.

The difficulty with governing is that, on the one hand, this should be as comfortable and imperceptible as possible for the rider. Therefore, a wide ramp and thus a wide speed interval is advantageous for governing. It should in this context also be noted that rapid fluctuations in motor assistance can also be perceived as disruptive by the rider's foot. Conversely, however, it is also desirable that further assistance be provided by the motor, even near the maximum allowable final speed. A narrow ramp and thus a low speed interval for governing is therefore also advantageous.

### SUMMARY

The method according to the present disclosure for controlling motor assistance provided by a motor of an electric bike comprises determining a variable rate of change of a governing factor, which defines the extent to which a governing factor changes over a defined time interval, wherein the rate of change is selected such that the governing factor is decremented if a current speed is greater than the target speed, and the governing factor is incremented if the current speed is less than the target speed; adjusting an existing governing factor based on the rate of change of the governing factor determined; and applying the governing factor calculated to a motor assistance determined for actuating the motor, wherein a greater governing factor results in greater motor assistance than a comparatively lesser governing factor.

The governing factor determines how much an initially determined motor assistance is to be restricted. In this case, the motor assistance determined for actuating the motor is in particular described by an assistance factor, a motor power determined for actuating the motor, and/or a motor torque determined for actuating the motor. The assistance factor, the desired motor power, and/or the desired motor torque in particular are initially determined, e.g., based on a provided rider torque, i.e., a torque that a rider of the electric bike applies to the pedals. These desired values are decreased according to the governing factor.

The variable rate of change of the governing factor describes how the governing factor changes over time. For example, if the governing factor is represented across a time period, then the rate of change describes a slope of this curve.

The rate of change is selected such that the governing factor is decremented when a current speed is greater than a target speed, and the governing factor is incremented when the current speed is less than the target speed. If the current speed is equal to the target speed, then the rate of change is zero, and the governing factor thus remains constant. In this context, a higher governing factor describes a lower restriction of the motor assistance than a comparatively lower governing factor. If the governing factor is equal to zero, then the motor assistance is completely suppressed. The motor assistance thus attempts to govern the current speed to the target speed, drives the electric bike faster than the target speed, reduces the motor assistance, slows it down, and the motor assistance is increased as much as possible.

The target speed is the speed to which the electric bike is to be restricted during operation with motor assistance.

In other words, this means that no motor assistance should be provided by the motor above the target speed, at least in the long term. However, such restriction does not mean that the target speed cannot be exceeded in the short term. According to the present disclosure, because the rate of change of the governing factor is changed, i.e., it is incremented or decremented, motor assistance can still be provided at a current speed that is greater than the target speed. The target speed can be selected in a variety of ways. For example, the target speed is a maximum assist speed, or a speed less than the maximum assist speed, if exceeding the maximum assist speed is not permitted, even if this is only done for a short time.

If a maximum speed (e.g., 27.5 km/h and thus higher than a target speed) is specified for the target speed (e.g., 25 km/h), then the rate of change is preferably selected such that the governing factor is zero when the maximum speed is exceeded. To this end, in particular at speeds between the target speed and the maximum speed based on the acceleration and the current speed, the time until the maximum speed is reached, and thus a rate of change, can be predetermined so that the motor assistance ends as smoothly as possible.

An adjustment of the existing governing factor is performed based on the rate of change of the governing factor determined. The rate of change of the governing factor is in this case preferably determined such that the motor assistance decreases over time when exceeding a target speed, and increases over time when falling below the target speed. The existing governing factor is changed accordingly. The rate of change thus defines a change of the governing factor over the time interval. This change will be calculated as part of the existing governing factor.

The governing factor is in particular a value by which the assistance factor, the determined motor power, and/or the determined motor torque is multiplied in order to apply the governing factor to the assistance factor.

Higher final speeds with at least consistent governing comfort are enabled as a result. At the same time, the method also enables further optimization, wherein in particular also different methods for determining motor assistance can be combined with the method according to the disclosure. For example, it can by means of any method be determined how much motor assistance is to be provided, and said assistance is governed based on the method according to the disclosure.

The rate of change is preferably set to govern a target speed or target speed as far as possible. In addition, the rate of change is preferably set such that motor power never increases or decreases too abruptly, and/or acceleration never changes too abruptly. Optionally, the rate of change is set such that motor power will be 0 when reaching a maximum allowable speed is projected. Further optionally, legally permissible temporary overshoots can be mapped over a maximum permissible speed by defining an amount of time to ramp down motor power when exceeding the maximum permissible speed.

Preferred further developments are disclosed hereinbelow.

Preferably, the rate of change is determined based on the current speed and a current acceleration. In this case, the current speed and the current acceleration are in particular determined by means of a sensor technology on the bike. In particular, a rapid decrease in the governing factor is caused by a corresponding rate of change if an existing acceleration indicates that there could be a wide overshoot of the target speed. It is thus avoided that a maximum assistance speed is significantly higher than the target speed.

In this context, it is advantageous if the rate of change is further determined based on additional measured variables, in particular a slope, a maximum motor torque, a rider torque, and/or a substrate of the bike detected by a substrate detection means. For example, governing can be smoother on a slope than on a downhill slope (e.g., to build momentum). Alternatively or additionally, governing on trails can be rougher in order to maximally assist the rider over rolling terrain.

Further, it is advantageous if the rate of change at an equal acceleration and an increasing current speed results in a faster decrementation of the derivation factor, and the rate of change at an equal speed and an increasing current acceleration results in a faster decrementation of the governing factor. In particular, it is advantageous if the rate of change causes the governing factor to be decremented faster when approaching the target speed and/or the maximum speed. The result is a particularly high rate of change being selected, especially at particularly high speeds and particularly high current accelerations, as a result of which a particularly responsive governing process takes place.

It is also advantageous if the rate of change is proportional to a difference between the current speed and the target speed. A simple method for adjusting the target speed is thus provided.

In addition, it is advantageous if the rate of change is proportional to a current acceleration and proportional to the reciprocal difference between the current speed and the maximum speed. A simple method for complete governing at the maximum speed is thus provided.

Also, it is advantageous if the rate of change is less than or equal to a current acceleration divided by a difference between the current speed and the maximum speed. A rate of change dependent on a current acceleration and a current speed can in this way be determined mathematically, quickly, and in a straightforward manner. In this case, the rate of change is selected such that the governing factor is always sufficiently small at the time of exceeding a maximum assistance speed projected based on the current speed and acceleration.

It is also advantageous if possible values of the rate of change are restricted to a predefined interval, e.g., [−10/sec . . . 10/sec]. Excessively jerky initiation or cessation of motor assistance is thus avoided. For example, premature motor restarting during rapid speed reduction can be prevented as a result. For example, during a jump, the wheels, and thus the motor of the bike, can rotate freely, resulting in a high sensed speed. This could result in a very high rate of change and, as a result, a very low governing factor and the associated strong abrupt governing if the rate of change is not restricted. When the bike then lands, the motor assistance would be governed first, but wheel braking would then suddenly take place and, based on the speed determined thereby, the ensuing positive rate of change would resume the motor assistance accordingly abruptly. However, this outcome is avoided if the rate of change is restricted to a predefined interval. Smooth initiation of the motor is thus achieved.

It is also advantageous if the governing factor is applied to the respectively lesser of a maximum allowable motor torque and a torque requested by a rider, in particular multiplied by it, in order to determine a requested torque to be provided by the motor. The requested motor torque is therefore first restricted before the governing factor is applied. The governing factor thus not only represents a restriction; it is also applied to the requested torque. It is thus ensured that the transitions are smooth when motor assistance is provided.

Furthermore, it is advantageous if the governing factor is restricted to a minimum value of 0 and a maximum value of 1. By thus defining the governing factor, it can be applied to assistance parameters determined by simple multiplication. For example, the assist factor, the determined motor power, or the determined motor torque can be simply multiplied by the governing factor in order to apply the governing factor.

It is also advantageous if, given a change in the current speed, the rate of change changes less strongly within a predefined speed interval around the target speed than at a speed above and/or below the speed interval. As a result, the motor assistance provided will gently vary around the target speed.

It is also advantageous if a maximum duration beyond which a maximum speed can be exceeded is defined, and the rate of change is selected, such that the governing factor is decremented in a way that the current speed drops below the maximum speed or the motor assistance drops to zero within the maximum duration. The rate of change is thus changed, in particular using an approximation to one end of the maximum duration, so that the governing factor is decremented more quickly. It can as a result be guaranteed that legal requirements in particular are reliably satisfied. The motor assistance drops to zero in particular if the rider pedals hard enough to exceed the maximum speed.

An apparatus for controlling motor assistance provided by a motor of an electric bike comprises a control unit configured to perform the method according to the disclosure. The apparatus includes all of the advantages of the method.

### BRIEF DESCRIPTION OF THE DRAWINGS

Embodiment examples of the disclosure are described in detail hereinafter with reference to the accompanying drawings. Shown are:

FIG. 1 a flow chart of a method for controlling assistance provided by a motor of an electric bike,

FIG. 2 a schematic diagram of an electric bike comprising an apparatus, by means of which the method according to the disclosure is performed,

FIG. 3 a graph depicting a relationship between the variable rate of change, a current speed, and a current acceleration,

FIG. 4 an advantageous relationship between the variable rate of change and a current speed, and

FIG. 5 a schematic diagram illustrating how to apply the motor torque determined for actuating the motor.

### DETAILED DESCRIPTION

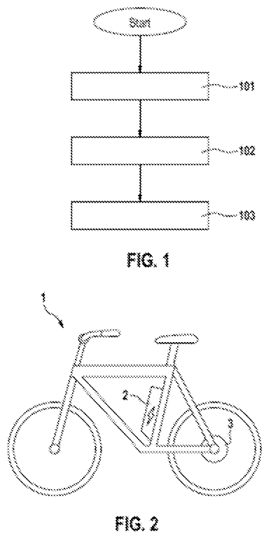

FIG. 1 shows a flow chart for a method 100 according to the present disclosure for controlling motor assistance provided by a motor of an electric bike 1. FIG. 2 shows an associated bike 1, which comprises a motor 3 and a control unit 2. The method 100 is performed by the control unit 2 of the electric bike 1, and the motor 3 is controlled accordingly.

The method comprises a first step 101, a second step 102, and a third step 103. After the method 100 begins, first step 101 is first performed.

In the first step 101, a variable rate of change of an governing factor is determined, which rate defines the extent to which a governing factor changes over a time interval. The governing factor in this case is a factor within a value range from 0 to 1 and thus has a minimum value of 0 and a maximum value of 1.

The governing factor is a factor describing the degree to which motor assistance is restricted. For example, the governing factor is multiplied by a determined assistance factor, a motor power determined for actuating the motor, and/or a torque determined for actuating the motor in order to restrict these values, and thus restrict the motor assistance provided by the bike. The assistance factor is a factor describing the motor torque to be provided, depending on a rider torque provided by a rider of the bike 1. If the assistance factor is multiplied by the governing factor, the resulting assistance factor decreases and motor assistance is also decreased. Accordingly, a motor power determined for actuating the motor can be multiplied by the governing factor, or a torque determined for actuating the motor can be multiplied by the governing factor to decrease it. It should be noted that the governing factor can take the value of 1. In this case, the motor assistance is not restricted. Also, the governing factor can take the value of 0, thereby completely inhibiting motor assistance.

A variable rate of change of the governing factor is determined. The rate of change is variable as it is continuously being redetermined. The method described herein is therefore preferably performed using a loop. The variable rate of change defines the extent to which the governing factor changes over a defined time interval. If the rate of change is high, then the governing factor changes faster over time than if the rate of change is comparatively lower.

The rate of change is chosen such that the governing factor is decremented when a current speed is greater than the target speed, and the governing factor is incremented when the current speed is less than the target speed. The rate of change is thus dependent on the current speed and the target speed. The current speed in this case is a speed sensed by a speed sensing means of the bike 1. The target speed is a speed at which the bike 1 should travel after a complete governing operation. The target speed is an applicable value. If the rate of change is a positive value, then the governing factor is increased over time, i.e. incremented. If the rate of change is a negative value, then the governing factor is reduced over its time course, i.e. decremented.

The longer the current speed is above the target speed, the more the governing factor is decremented. Given a decreasing governing factor, motor assistance is simultaneously reduced, which either reduces the current speed or requires more force to be applied by the rider of the bike 1, which force would ultimately also have to be provided entirely without motor assistance. If the current speed is below the target speed, then the rate of change is selected such that the governing factor is incremented, ultimately leading to the governing factor approaching the value of 1, and the motor assistance provided thus not being reduced by the governing factor. As a result, full motor assistance provided below the target speed after a brief period. At the same time, the motor assistance above the target speed is reduced according to the rate of change and the governing factor. It should be noted, however, that only the rate of change is determined according to the disclosure, and the governing factor is determined based on the rate of change. The result thereby can also be excessive motor assistance. For example, it is thus not necessarily certain that the target speed will be exceeded and that no motor assistance will be provided at the same time. However, it is ensured that the rate of change at such a time is selected such that the governing factor continuously changes in one direction, so that the motor assistance is reduced.

In one exemplary embodiment, determining the variable rate of change takes place in a speed-dependent manner. For example, the rate of change could be determined based on the following formula, wherein dfₐ is the rate of change:

$${fd}_{a} = ( 1 - \frac{v - 20 kmh}{5 kmh} ) / 1 s$$

In this context, v is the current speed, wherein the target speed is selected as, e.g., 25 km/h, and a governing operation is to be performed in a speed interval between 20 km/h and 25 km/h. The value of 20 km/h is an exemplary value which describes a speed at which a governing operation is to begin. The value of 5 km/h is an example of a speed interval within which the governing procedure is to take place. For example, governing is to begin in this case at a speed of 20 km/h and be completed at a speed of 25 km/h. The speed of 25 km/h is thus the target speed at which the rate of change is equal to 0.

Instead of determining the rate of change based on the current speed and the target speed, the rate of change is optionally additionally determined based on the current acceleration. For example, the rate of change is determined based on the following formula:

$${df}_{a} \leq \frac{a}{v - {v}_{max}}$$

a describes the current acceleration, v describes the current speed, and vₘₐₓ describes the target speed. The rate of change according to the formula described above is less than or equal to a current acceleration divided by a difference between the current speed and the target speed.

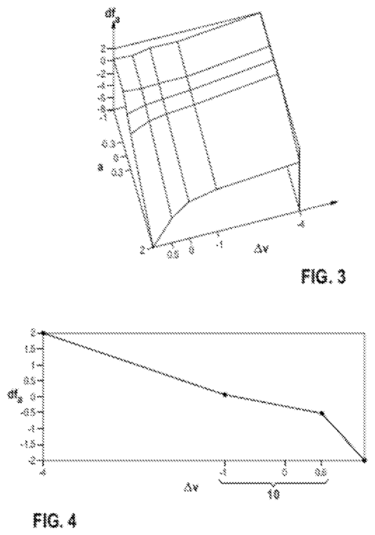

In any event, the goal in this case is for the rate of change at an equal acceleration and an increasing current speed to lead to a faster decrementation of the governing factor, and for the rate of change at an equal speed and an increasing current acceleration to lead to a faster decrementation of the governing factor. Therefore, a relationship exists between the rate of change and two different parameters, in this case the current speed and the current acceleration. This is illustrated by way of example in FIG. 3, which shows an exemplary rate of change characteristic map. The rate of change dfₐ is in this case shown along a first axis in a range of values from −8 to +2. The values indicate to what extent the governing factor is to change to 1 s. If the rate of change is positive, then the governing factor is incremented. If the rate of change is negative, then the governing factor is decremented. The acceleration a is shown via a second axis. A range of values from −1 to 2 is shown in this case. Positive values correspond in this case to a positive acceleration, and negative values correspond to a negative acceleration, i.e., a deceleration. A deviation Δv of the current speed from the target speed is shown via a third axis. The value described along the third axis is thus calculated from the current speed minus the target speed. If the speed difference, and thus the deviation Δv, is less than 0, then the current speed is below the target speed. If the speed difference, and thus the deviation Δv, is greater than 0, then the current speed is above the target speed.

It can be seen that one surface is stretched, which enables the rate of change to be indicated as a function of the current speed and acceleration. For example, it can be seen that a particularly high amount for the rate of change is selected at particularly high speeds and accelerations above the target speed. The rate of change in this case is thus negatively selected to have a comparatively high amount, which leads to the governing factor being decremented (given the high amount), quickly (due to the negative indication), and approaching the value 0. Motor assistance is then disengaged particularly quickly. If the current speed is equal to the target speed, i.e., the deviation Δv is equal to 0, and the current acceleration a is equal to 0, then the rate of change is selected to a value of 0, and the existing governing factor is maintained unchanged.

So, the target speed for governing is defined as, e.g., 25 km/h. Preferably, a speed range above the target speed is also defined by only temporary assistance: The motor assistance must end within a defined time. Assistance is once again provided below 25 km/h. In addition, the acceleration is taken into account in order to anticipate or exclude exceeding the target speed.

In FIG. 3, it is exemplarily illustrated how the rate of change can be selected as a function of the current speed. FIG. 4 describes either a cross section through the surface shown in FIG. 3, wherein the acceleration is selected to be 0, or the figure alternatively describes a determination of the rate of change independent of the current acceleration. In FIG. 4, the rate of change dfₐ is shown along a y-axis in a range of values from −2 to +2. The values indicate to what extent the governing factor is to change to 1 s. The deviation Δv of the current speed from the target speed is shown via an x-axis.

In this context, it can be seen from FIG. 4 that the rate of change changes faster in a speed-dependent manner below a speed interval 10 defined around the target speed than within the speed interval 10. In a corresponding manner, the rate of change changes in a speed dependent manner faster above the defined speed interval 10 than within the speed interval 10.

This means that the system will be more sensitive to speed changes if the current speed deviates further from the target speed. It can in this way be achieved that a gentle governing of the target speed takes place near the target speed by only slightly changing the rate of change. However, deviating yet further from the target speed can result in rapid responses by the system, e.g., in order to avoid a long-term exceedance of a maximum speed or a long-term undershooting of a minimum speed. Preferably, the limits of the speed interval 10 are defined by the minimum speed and the maximum speed.

Optionally, the rate of change is restricted to a predefined interval. This means that a minimum value and a maximum value for the rate of change are defined and cannot be outside of that interval. For example, according to FIG. 3 the rate of change could be restricted to an interval from −8 to 2. A computational restriction on the rate of change dfₐ could be provided as follows:

$$- \frac{0.5}{s} \leq {df}_{a} \leq \frac{0.5}{s}$$

By such a restriction of the rate of change, it can be avoided that the motor 3 will restart too quickly upon a rapid speed reduction. For example, it can be the case that a wheel of the bike 1 rotates freely during a jump, thus leading to the sensing of a high current speed. However, this speed is theoretically too high since it is only achieved by free rotation of the wheel. In order to avoid the provided motor assistance being fully governed immediately, it is advantageous to restrict the rate of change. Although motor assistance is reduced slightly within the time elapsed during the jump, it is not reduced to the point that it leads to a rapid braking of the bike 1. A smooth start of the motor 3 when landing after a jump can thus be achieved.

In the second method step 102, an adjustment of an existing governing factor is made based on the rate of change of the governing factor determined. For example, a time interval since the last setting of the governing factor is determined for this purpose and, based on the rate of change determined, it is determined how much the governing factor has changed within this time interval. To this end, the rate of change is, e.g., multiplied by the time interval, and the value determined is added to the current governing factor. The governing factor is reset accordingly. A mathematical description might resemble the following:

fₐ(t+dt)=max[min[fₐ(t)+dfₐ*dt:1];0]

The function fₐ(t) in this case describes the time progression of the governing factor, dfₐ describes the rate of change, and dt describes the time interval since the last setting of the governing factor. The governing factor in this case is selected such that it is not less than 0 and not greater than 1.

In the third step 103, an assistance factor determined for actuating the motor 3, the motor power determined for actuating the motor 3, and/or the motor torque determined for actuating the motor 3 are applied to the governing factor calculated during the second step 102. The values described above are multiplied by the governing factor for this purpose. The values calculated in this manner are provided as target values for the control of motor assistance and are provided by the motor 3 to the rider.

In particular, if legal requirements are to be met, it is advantageous if a maximum duration is defined, beyond which a maximum speed can be exceeded. In that case, the rate of change is selected such that the governing factor is incremented in a way the current speed drops below the maximum speed within the maximum time. For example, a remaining time interval can be continuously determined, within which interval the speed must drop to the maximum speed. As the duration of the time interval decreases, for example, the governing factor is decremented more rapidly, i.e., the rate of change is increased.

If the relationship between motor assistance and acceleration is known or can be estimated, then this relationship can be advantageously utilized. For example, the goal of the governor can be for acceleration to be adjusted during an operating state in order to be as harmonious as possible at a limit speed of 0. For example, the bike 1 is constantly accelerated starting at 15 km/h. Starting at a speed of 20 km/h, the governor can decide to engage and adjust system power so that the acceleration determined is equally reduced such that it becomes 0 at a maximum speed of 25 km/h, if possible. In this case, the governor change necessary for this purpose is calculated based on contextual knowledge. In this case, a desired change in acceleration (depending on the operating point) results in a necessary change in the motor assistance and thus an associated change in the governing factor.

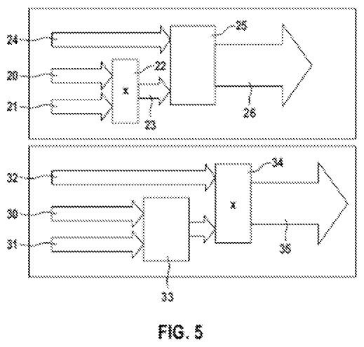

FIG. 5 shows a flow chart of a method 100 according to the disclosure to illustrate the differences compared to the prior art. For example, a conventional method is shown in FIG. 5 above. It has thus been customary until now for a governing factor 20 to be selected and multiplied by a maximum allowable motor torque 21 during a multiplication step 22. The resulting motor torque 23 was compared to a motor torque 24 requested by a rider during a comparison step 25, and the respective lesser of these two values 26 was provided for actuating the motor 3 in order to describe a requested motor torque via said speed governing.

The principle behind the present disclosure is again illustrated at the bottom of FIG. 5. The maximum allowable motor torque 31 is thus initially compared with the motor torque 30 requested by the rider, and the lesser of these two torques are selected during a comparative step 33. The result is multiplied by the governing factor 32 during a multiplication step 34, and the resulting motor torque 35 is provided as the requested motor torque from the speed governor.

A method for the speed-related governing of an electric bike is provided as a result. In this case, what each governor has in common is that a governing factor is determined, e.g., applied to the assist factor and/or current/maximum motor torque/power. This governing factor has conventionally been directly derived from a speed-dependent ramp.

According to the disclosure, the governing factor is no longer directly dependent on speed (or acceleration, etc.), but rather the rate of change of the governing factor is defined. In the simplest implementation (speed dependent only), the rate of change is negative when a current speed is above the governing speed and positive when the current speed is below the governing speed. This can be simply defined by a linear relationship.

In one preferred embodiment, the rate of change is dependent on the current speed and the current acceleration of the bike 1. Together, these variables result in the phase space (a full description of the current relevant dynamics). In addition, the current performance of the overall system can also be considered. The rate of change is continuously adjusted, depending on the current speed and acceleration (or other variables).

It is noticeable that temporary assistance is also possible above the target speed, but the system reliably ends the assistance if the target speed is exceeded in the long term. By skillfully selecting the rate of change, the latter can be advantageously utilized.

Preferably, the rate of change is selected such that the governing factor is always sufficiently small at the time of exceeding a maximum speed projected based on the current speed and acceleration.

In addition to the written disclosure hereinabove, we make explicit reference to the disclosure of FIGS. 1 to 5.

What is claimed is:

1. A method for controlling motor assistance provided by a motor of an electric bike, comprising:
determining a variable rate of change of a governing factor defining the extent to which a governing factor changes over a defined time interval, wherein the rate of change is selected such that the governing factor is decremented when a current speed is greater than a target speed, and the governing factor is incremented when the current speed is less than the target speed;
adjusting an existing governing factor based on the rate of change of the governing factor determined; and
applying a motor assistance determined for actuating the motor using the governing factor calculated, wherein a greater governing factor results in greater motor assistance than a comparatively lesser governing factor.

2. The method according to claim 1, wherein the rate of change is determined based on the current speed and a current acceleration.

3. The method according to claim 2, wherein the rate of change is further determined based on additional measured variables detected by a substrate detection device.

4. The method according to claim 2, wherein:
the rate of change at an equal acceleration and an increasing current speed leads to a faster decrementation of the governing factor, and
the rate of change at an equal speed and an increasing current acceleration leads to a faster decrementation of the governing factor.

5. The method according to claim 1, wherein:
the rate of change is proportional to a difference between the current speed and the maximum speed, or
the rate of change is proportional to a current acceleration and proportional to the reciprocal difference between the current speed and the maximum speed.

6. The method according to claim 1, wherein the possible values of the rate of change are restricted to a predefined interval, and/or the governing factor is restricted to a minimum value of “0” and a maximum value of “1”.

7. The method according to claim 1, wherein the governing factor is applied to the respectively lesser of a maximum allowable motor torque and a torque requested by a rider in order to determine a requested torque to be provided by the motor.

8. The method according to claim 1, wherein:
given a change in the current speed, the rate of change changes less within a predefined speed interval around the target speed than at a speed above and/or below the speed interval.

9. The method according to claim 1, wherein:
a maximum duration beyond which a maximum speed can be exceeded is defined, and
the rate of change is selected such that the governing factor is decremented in a way that the current speed drops below the maximum speed or the motor assistance drops to zero within the maximum duration.

10. An apparatus for controlling motor assistance provided by a motor of an electric bike, comprising a control unit configured to perform the method according to claim 1.

11. The method according to claim 2, wherein the additional measured variables include one or more of the following: a slope, a maximum motor torque, a rider torque, and a substrate of the bike.

12. The method according to claim 1, wherein the governing factor is applied to the respectively lesser of a maximum allowable motor torque and a torque requested by a rider multiplied by said torque in order to determine a requested torque to be provided by the motor.
